(19) United States
(12) Patent Application Publication
(10) Pub. No.: US 2020/0218662 A1
(43) Pub. Date: Jul. 9, 2020

(54) DATA CACHING DEVICE AND CONTROL METHOD THEREFOR, DATA PROCESSING CHIP, AND DATA PROCESSING SYSTEM

(71) Applicant: SZ DJI TECHNOLOGY CO., LTD., Shenzhen (CN)

(72) Inventors: Zimu REN, Shenzhen (CN); Bin HAN, Shenzhen (CN)

(21) Appl. No.: 16/820,245

(22) Filed: Mar. 16, 2020

Related U.S. Application Data
(63) Continuation of application No. PCT/CN2017/104323, filed on Sep. 29, 2017.

(51) Int. Cl. G06F 12/0879; G06F 9/30; G06F 9/48

(52) U.S. Cl. CPC G06F 12/0879; G06F 9/30098; G06F 9/485; G06F 9/30065

(57) ABSTRACT

A data caching device includes a first recorder, configured to record busy identifiers and idle identifiers in a plurality of read identifiers with each busy identifier corresponding to a data burst to be read; and a cache, including a head pointer and a tail pointer for performing loop access to the cache, and a cache space defined by the head pointer and the tail pointer. Corresponding to each busy identifier, the cache space includes a cache subspace for storing the corresponding data burst. The data caching device also includes a controller, configured to write the data burst read from a memory into the cache subspace corresponding to each busy identifier in a preset order, and in response to a last data block of the data burst being written in the cache subspace, update the first recorder, and change the busy identifier to an idle identifier.

### CROSS-REFERENCE TO RELATED APPLICATION

This application is a continuation of International Application No. PCT/CN2017/104323, filed Sep. 29, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure generally relates to the field of information processing and, more particularly, relates to a data caching device and control method thereof, a data processing chip, and a data processing system.

### BACKGROUND

With improvement of processing efficiency of data processing chip, the data processing speed of the data processing chip is getting faster and faster. The data processing speed of a data processing chip is often faster than the speed at which the data processing chip reads data from an external storage unit to an internal caching unit, e.g. the speed at which the data processing chip moves data from an external storage unit to an internal caching unit. Therefore, for a data processing chip, the reading speed of external data becomes a bottleneck which restricts the data processing efficiency of the data processing chip.

In order to alleviate the restriction on the data processing efficiency of the data processing chip due to the slow speed of reading external data, a conventional data processing chip includes a large-capacity caching unit disposed inside the chip. As a result, in the conventional data processing process, a large amount of on-chip cache resources has to be consumed.

### SUMMARY

One aspect of the present disclosure provides a data caching device. The data caching device includes a first recorder, configured to record busy identifiers and idle identifiers in a plurality of read identifiers with each busy identifier corresponding to a data burst to be read; and a cache, including a head pointer, a tail pointer, and a cache space defined by the head pointer and the tail pointer. The head pointer and the tail pointer are configured to perform loop access to the cache. The cache space includes a cache subspace corresponding to each busy identifier. The cache subspace corresponding to each busy identifier is configured to store the corresponding data burst. The data caching device also includes a controller, configured to write a data burst read from a memory into the cache subspace corresponding to each busy identifier in a preset order, and in response to a last data block of the data burst being written in the cache subspace corresponding to the busy identifier, update the first recorder, and change the busy identifier to an idle identifier.

Another aspect of the present disclosure provides a data processing chip. The data processing chip includes a data caching device and a data processing device. The a data processing device is connected to the data caching device and configured to process data received by the data caching device. The data caching device includes a first recorder, configured to record busy identifiers and idle identifiers in a plurality of read identifiers with each busy identifier corresponding to a data burst to be read; and a cache, including a head pointer, a tail pointer, and a cache space defined by the head pointer and the tail pointer. The head pointer and the tail pointer are configured to perform loop access to the cache. The cache space includes a cache subspace corresponding to each busy identifier. The cache subspace corresponding to each busy identifier is configured to store the corresponding data burst. The data caching device also includes a controller, configured to write a data burst read from a memory into the cache subspace corresponding to each busy identifier in a preset order, and in response to a last data block of the data burst being written in the cache subspace corresponding to the busy identifier, update the first recorder, and change the busy identifier to an idle identifier.

Another aspect of the present disclosure provides a data processing system. The data processing system includes a bus; a data processing chip, including a data caching device and a data processing device; and a central processing unit (CPU), connected to the data processing chip through the bus. The data processing device is connected to the data caching device and configured to process data received by the data caching device. The data caching device includes a first recorder, configured to record busy identifiers and idle identifiers in a plurality of read identifiers with each busy identifier corresponding to a data burst to be read; and a cache, including a head pointer, a tail pointer, and a cache space defined by the head pointer and the tail pointer. The head pointer and the tail pointer are configured to perform loop access to the cache. The cache space includes a cache subspace corresponding to each busy identifier. The cache subspace corresponding to each busy identifier is configured to store the corresponding data burst. The data caching device also includes a controller, configured to write a data burst read from a memory into the cache subspace corresponding to each busy identifier in a preset order, and in response to a last data block of the data burst being written in the cache subspace corresponding to the busy identifier, update the first recorder, and change the busy identifier to an idle identifier.

Other aspects of the present disclosure can be understood by those skilled in the art in light of the description, the claims, and the drawings of the present disclosure.

### BRIEF DESCRIPTION OF THE DRAWINGS

In order to more clearly illustrate the technical solutions in the embodiments of the present disclosure, the drawings that need to be used in the description of the embodiments will be briefly described below. It is obvious that the drawings in the following description are some embodiments of the present disclosure, and for those of ordinary skill in the art, other drawings may also be obtained according to these drawings without any creative effort.

FIG. 1 illustrates a schematic structural diagram of a data processing system where an exemplary data processing method according to various embodiments of the present disclosure is applicable;

FIG. 2 illustrates a schematic structural diagram of an exemplary data caching device according to an embodiment of the present disclosure;

FIG. 3 illustrates a schematic flowchart of an exemplary control method of a data caching device according to an embodiment of the present disclosure;

FIG. 4 illustrates a schematic structural diagram of another exemplary data caching device according to an embodiment of the present disclosure;

FIG. 5 illustrates a schematic diagram of an exemplary implementation of a first recorder and a second recorder according to an embodiment of the present disclosure;

FIG. 6 illustrates a schematic flowchart of an implementation manner of an exemplary step 310 shown in FIG. 3;

FIG. 7 illustrates a schematic flowchart of another exemplary method for controlling a data caching device according to an embodiment of the present disclosure;

FIG. 8 illustrates a schematic flowchart of another exemplary method for controlling a data caching device according to an embodiment of the present disclosure;

FIG. 9 illustrates a schematic flowchart of another exemplary method for controlling a data caching device according to an embodiment of the present disclosure; and

FIG. 10 illustrates a schematic structural diagram of another exemplary data caching device according to an embodiment of the present disclosure.

### DETAILED DESCRIPTION OF THE EMBODIMENTS

In the following, the technical solutions in the embodiments of the present disclosure will be clearly described with reference to the accompanying drawings in the embodiments of the present disclosure. It is obvious that the described embodiments are only a part of the embodiments of the present invention, but not all of the embodiments. All other embodiments obtained by those skilled in the art based on the embodiments of the present disclosure without creative efforts are within the scope of the present disclosure.

It should be noted that when a component is referred to as being “fixed” to another component, it can be directly on the other component or an intermediate component may be present. When a component is considered as “connected to” another component, it can be directly connected to another component or both may be connected to an intermediate component.

All technical and scientific terms used herein have the same meaning as commonly understood by one of ordinary skill in the art to which this disclosure belongs, unless otherwise defined. The terminology used in the description of the present disclosure is for the purpose of describing particular embodiments and is not intended to limit the disclosure. The term “and/or” used herein includes any and all combinations of one or more of the associated listed items.

Some embodiments of the present disclosure are described in detail below with reference to the accompanying drawings. The features of the embodiments and examples described below can be combined with each other without conflict.

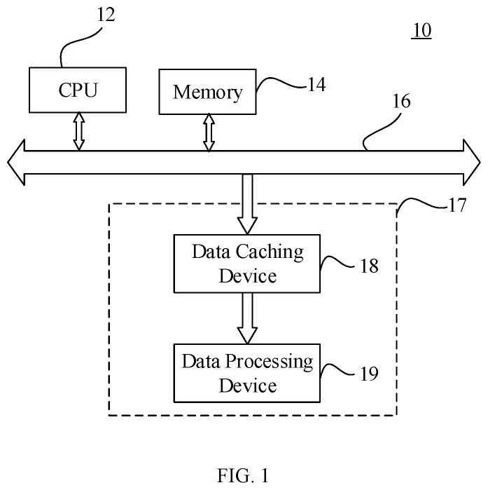

FIG. 1 illustrates a schematic structural diagram of a data processing system where an exemplary data processing method according to various embodiments of the present disclosure is applicable. Referring to FIG. 1, the data processing system 10 may include a central processing unit (CPU) 12, a memory 14, a bus 16, and a data processing chip 17. The CPU 12, the memory 14, and the data processing chip 17 may be connected with each other through the bus 16.

The CPU 12 may be responsible for the management and the control of the entire data processing system 10, and may perform data operation tasks.

The memory 14 may be a double data rate (DDR) memory. The memory 14 may be used to store data obtained from the outside of the data processing system 10. For example, the memory may be used to store data read from an external disk. The data stored in the memory may be used by the CPU 12, or may be used by the data processing chip 17.

The bus 16 may be regarded as a channel for communication and data interaction between various modules n the data processing system 10. The bus 16 may be implemented in various forms. For example the bus 16 may be an advanced extensible interface (AXI) bus, or any other types of internal buses.

The data processing chip 17 may include a data caching device 18 and a data processing device 19.

The data caching device 18 may be used to read data or data burst from the memory 14. For example, the data caching device 18 may read a data burst from the memory 14 under the control of the CPU 12. In another example, the data caching device 18 may read a data burst from the memory 14 in a direct memory access (DMA) manner. In one embodiment, a cache may be provided inside the data caching device 18, and the data caching device 18 may cache the data read from the memory 14 to the internal cache for the data processing device 19 to use.

In some embodiments, a data burst may also be referred to as a bust or a burst of data. A data burst may generally include multiple data blocks. For example, a data burst may include 8 data blocks. The quantity (i.e., number) of data blocks included in one data bust may be represented by a burst length (BL) of the data burst.

The data caching device 18 may be a data caching device that supports outstanding transmission. Outstanding transmission may indicate that the next read request can be sent without waiting for the previous read request to be processed, and the data burst corresponding to the read request sent later can be returned first. Outstanding transmission can improve the data reading efficiency of the data processing system 10.

The data processing device 19 may perform data operation based on the data cached by the data caching device 18. It should be understood that both the CPU 12 and the data processing device 19 can perform data operation based on the data in the memory. The types of data that the CPU 12 needs to process and the types of data that the data processing device 19 needs to process may be related to actual applications, which are not specifically limited in the present disclosure. For example, the CPU 12 may be used to process general-purpose data, and the data processing device 19 may be specifically used to process data of a certain type or data related to a certain application, such as image data.

The data processing speed of the data processing chip 17 may often be greater than the speed at which the data processing chip 17 reads data bursts to (or moves data bursts to) the data caching device 18 from the memory 14. Therefore, for the data processing chip 17, the reading speed of external data becomes a bottleneck that restricts the data processing efficiency of the data processing chip 17.

In order to alleviate the restriction on the data processing efficiency of the data processing chip due to the reading speed of external data, a conventional data caching device generally includes an internal cache with a large capacity, which results in the consumption of a large amount of the on-chip cache resources.

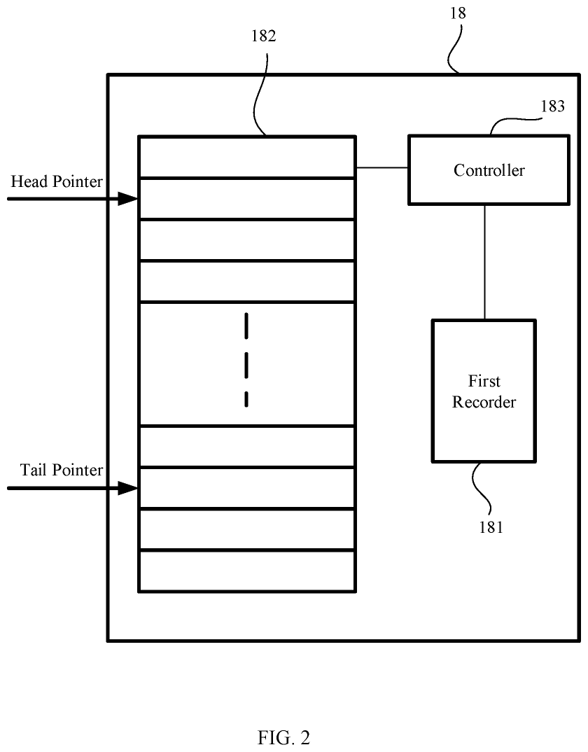

The present disclosure provides a data caching device to reduce the on-chip cache resources required during a data processing process. FIG. 2 illustrates a schematic structural diagram of an exemplary data caching device according to an embodiment of the present disclosure. Referring to FIG. 2, the data caching device 18 may include a first recorder 181, a cache 182, and a controller 183.

In one embodiment, the first recorder 181 may be configured to record busy identifiers and idle identifiers in a plurality of read identifiers (or referred to as read IDs). The plurality of read identifiers may be preset. The number of the plurality of read identifiers may represent the number of read requests transmitted in an outstanding transmission manner supported by the data caching device 18. Taking the number of the plurality of read identifiers equal to 8 as an example, the data caching device 18 may be able to support 8 read requests to be transmitted in an outstanding transmission manner. For illustrative purposes, in the following, transmitting 8 read requests in the outstanding transmission manner is referred to as outstanding8.

The plurality of read identifiers may include busy identifiers and idle identifiers. A read identifier set as a busy identifier may indicate that the data caching device 18 is reading a data burst corresponding to the read identifier. Therefore, each busy identifier may correspond to one data burst to be read. A read identifier set as an idle identifier may indicate that the data caching device 18 has not read the data burst corresponding to the read identifier. Alternatively, a read identifier set as an idle identifier may indicate that the read identifier is in an idle state and can be used to read a new data burst.

The first recorder 181 may be configured to record the busy/idle statuses of the plurality of read identifiers. The first recorder 181 may be, for example, a register, or another type of storage unit. Taking outstanding8 as an example, the data caching device 18 may be configured to include eight read identifiers. In one embodiment, the first recorder 181 may be an 8-bit register, and each bit of the register may correspond to a read identifier. When the value of a bit is 1, the read identifier corresponding to this bit may be a busy identifier. When the value of a bit is 0, the read identifier corresponding to this bit may be an idle identifier. That is, a bit having a value of 1 may indicate that the read identifier corresponding to this bit is a busy identifier, and a bit having a value of 0 may indicate that the read identifier corresponding to this bit is an idle identifier.

The cache 182 may include a head pointer and or a tail pointer for performing a loop access to the cache 182. The so-called loop access may refer to that when the address pointed by the tail pointer reaches the end address of the cache 182, and the tail pointer needs to continue to move, the next address pointed by the tail pointer may be changed to the first address of the cache 182. By using the head pointer and the tail pointer, the storage space of the cache 182 can be recycled. In some embodiments, the cache 182 may be, for example, a first-in-first-out (FIFO) queue.

Further, the cache 182 may include a cache space defined by the head pointer and the tail pointer. The cache space may occupy part or all of the address range of the cache 182. The cache space defined by the head pointer and the tail pointer can be understood as that the cache space starts with an address pointed by the head pointer and ends with an address pointed to by the tail pointer.

The cache space may include a cache subspace corresponding to each busy identifier, and the cache subspace corresponding to each busy identifier may be used to store a corresponding data burst (that is, a data burst corresponding to each busy identifier).

In one embodiment, taking a data burst containing 8 data blocks, and each data block occupying 1 storage address in the cache space as an example, the cache subspace corresponding to each busy identifier may occupy 8 consecutive storage addresses of the cache 182. Assuming that the number of busy identifiers is three, the cache space described above may be composed of 24 consecutive storage addresses in the cache 182.

In some embodiments, the cache 182 may be implemented using, for example, a random access memory (RAM).

The embodiments of the present disclosure do not specifically limit the interface bit width and capacity of the cache 182, which may be determined according to actual needs. For example, to simplify the implementation, the interface bit width of the cache 182 may be configured to be equal to the read-data bit width of the bus 16. Further, in some embodiments, the capacity of the cache 182 may be configured to be 1.5 times, 2 times, or 2.5 times the total amount of data in a data burst transmitted in an outstanding transmission manner that the data caching device 18 is able to support.

In one embodiment, taking the data caching device 18 supporting outstanding8 (that is, the data caching device 18 supports transmitting 8 data bursts in an outstanding transmission manner) as an example, and assuming that each data burst contains 8 data blocks, the capacity of the cache 182 may be configured to be twice the amount of data occupied by the 8 data bursts. Assuming that one storage address of the cache 182 is used to store one data block, the address depth of the storage address of the cache 182 may be set to 8×8×2=128.

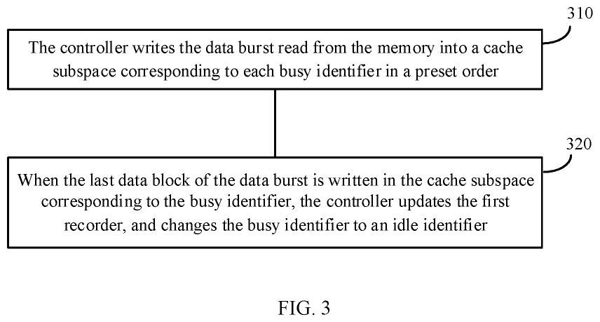

The controller 183 may be configured to perform a logic control function related to the data caching device 18. For example, FIG. 3 illustrates a schematic flowchart of an exemplary control method of a data caching device according to an embodiment of the present disclosure. Referring to FIG. 3, the controller 183 may be configured to execute a control method, including exemplary steps 310-320, which are described in detail below.

In the exemplary step 310, the controller 183 may write the data burst read from the memory into a cache subspace corresponding to each busy identifier in a preset order.

There are multiple ways to define the preset order. In one embodiment, the controller 183 may, according to the response order of the memory 14 to the read request corresponding to each identifier in the busy identifiers (e.g., the order in which the memory 14 responds to the read request corresponding to each identifier in the busy identifiers), sequentially write the data burst corresponding to each identifier in the busy identifiers into the cache subspace corresponding to the identifier. In other words, the sequence of the data bursts read by the data caching device 18 may be related to the response order of the memory to the read request, and a data burst corresponding to a read request sent later can be read back first. For example, when the data caching device 18 first reads a data burst corresponding to a busy identifier, it may finish reading the data burst corresponding to the busy identifier before reading the data burst corresponding to the next busy identifier. The reading order may depend on the order in which the data burst corresponding to the busy identifier is returned, and this order may be the same as the sending order of the read request or may be different from the sending order of the read request. According to various embodiments of the present disclosure, data bursts are read based on the response order of the corresponding read requests, thereby supporting the outstanding transmission of data bursts. As such, the data reading efficiency may be improved.

Further, on the basis of the above embodiment, the controller 183 may, according to the reading order of the data blocks in the data burst corresponding to each identifier in the busy identifiers (e.g., the order in which the data block in the data burst corresponding to each identifier in the busy identifiers are read), sequentially write the data blocks in the data burst corresponding to each identifier in the busy identifiers into the cache subspace corresponding to the identifier. For example, data blocks in the data bursts of the busy identifiers may be read in an interleaved manner. In one embodiment, a first data block in the data burst corresponding to a busy identifier with id=3 can be read in the n^{th} clock cycle; then, a first data block in the data burst corresponding to a busy identifier with id=1 may be read in the next clock cycle; and further, a second data block of the data burst corresponding to the busy identifier with id=3 may be read in the next clock cycle. As shown in the above data block reading process, the controller 183 provided in the embodiments of the present disclosure may be able to read the data blocks corresponding to the busy identifiers in an interleaved manner. As such, the data reading efficiency of the data caching device 18 may be further improved.

In the exemplary step 320, when the last data block of the data burst is written in the cache subspace corresponding to the busy identifier, the controller 183 may update the first recorder, and change the busy identifier to an idle identifier. It should be understood that writing the last data block of a corresponding data burst to a cache subspace corresponding to the busy identifier indicates that reading of the data burst corresponding to the busy identifier is completed. In this situation, according to the embodiments of the present disclosure, by updating the first recorder 181, the busy identifier may be reset to an idle identifier to read subsequent data bursts. According to the embodiments of the present disclosure, the busy/idle status of a read identifier may be recorded, and a used busy identifier (e.g., reading the data burst corresponding to the busy identifier is completed) may be updated to an idle identifier, such that the read identifier may continue to be used to read subsequent data bursts, thereby improving the outstanding utilization rate.

There are various ways for the controller 183 to determine whether the last data block of the data burst is written into the cache subspace corresponding to the busy identifier, which are not specifically limited in the present disclosure. As an example, the quantity of the data blocks written in the cache subspace corresponding to the busy identifier may be recorded. When the quantity of the data blocks written in the cache subspace corresponding to the busy identifier is equal to the quantity of the data blocks contained in the data burst, then it may be determined that the last data block of the data burst is written into the cache subspace corresponding to the busy identifier. Taking a data burst containing 8 data blocks as an example, when the cache subspace corresponding to a busy identifier has been written with 8 data blocks, it may be determined that the cache subspace corresponding to the busy identifier has been written in the last data block of the data burst.

As another example, it can be determined whether the newly written data block is stored at the end address of the cache subspace corresponding to the busy identifier. When the newly written data block is stored at the end address of the cache subspace corresponding to the busy identifier, it may be determined that the last data block of the data burst is written into the cache subspace corresponding to the busy identifier.

According to the embodiments of the present disclosure, the data caching device 18 may implement the recycling of the cache space based on the head pointer, the tail pointer, and the first recorder for recording the busy/idle status. As such, the number of on-chip cache resources required for the data processing process may be reduced to a certain extent.

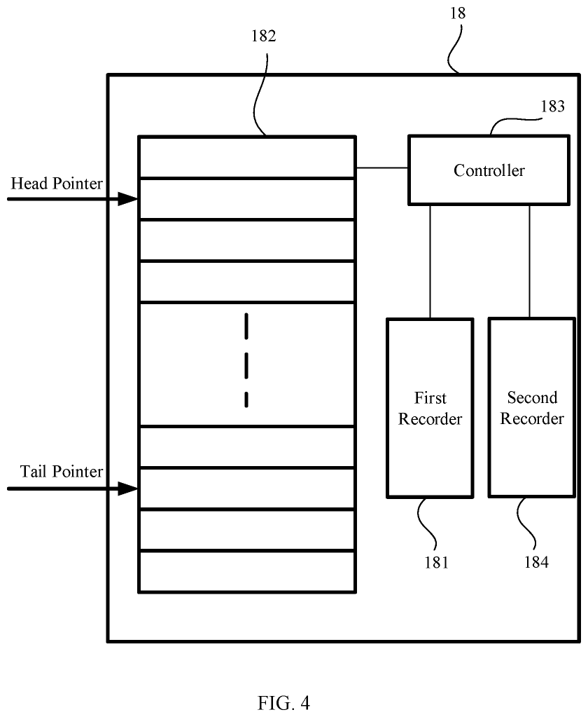

FIG. 4 illustrates a schematic structural diagram of another exemplary data caching device according to an embodiment of the present disclosure. Referring to FIG. 4, in some embodiments, the data caching device 18 may further include a second recorder 184. The second recorder 184 may be configured to record a target storage address of the cache subspace corresponding to the busy identifier. The target storage address may be a storage address of a next data block in the data burst corresponding to the busy identifier. The initial value of the target storage address may be set to the first address of the cache subspace corresponding to the busy identifier. In this case, the next data block in the data burst corresponding to the busy identifier may refer to the first data block of the data burst. According to the embodiments of the present disclosure, a second recorder may be introduced to record the storage address of a data block in the data burst corresponding to the busy identifier, and the controller 183 may determine the storage address of each data block read from the memory 14 through a simple query operation. As such, the control logic of the controller 183 may be simplified.

In one embodiment, the second recorder 184 may be implemented by a register. In other embodiments, the second recorder 184 may be implemented by other types of storage units. For example, the second recorder 184 may include a register file composed of registers. Each row of the register file may correspond to a read identifier of a plurality of read identifiers.

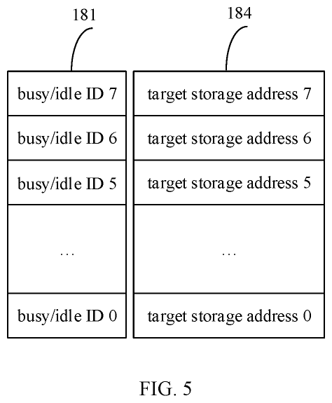

FIG. 5 illustrates a schematic diagram of an exemplary implementation of a first recorder 181 and a second recorder 184 according to an embodiment of the present disclosure. Referring to FIG. 5, in one embodiment, taking outstanding8 as an example, the data caching device 18 may be preset with eight read identifiers, which are denoted by id0 to id7 in the following. As shown in FIG. 5, the first recorder 181 may include an 8-bit register, which records 8 busy/idle identifiers, e.g. the busy/idle identifiers 0 to 7 in FIG. 5, corresponding to the 8 read identifiers, respectively. Taking the busy/idle identifier 0 as an example, when the value of the busy/idle identifier 0 is 1, it may indicate that id0 is a busy identifier; when the value of the free and busy identifier 0 is 0, it may indicate that id0 is an idle identifier. Further, the second recorder 184 may be a register file composed of a plurality of registers. The register file may contain eight target storage addresses, e.g. target storage address 0 to target storage address 7 in FIG. 5, corresponding to the eight read identifiers, respectively. Taking target storage address 0 as an example, when id0 is a busy identifier, the initial value of target storage address 0 may be set to the starting address of the cache subspace corresponding to id0. Then, each time a data block in the data burst corresponding to id0 is read back by the data caching device 18, target storage address 0 may be increased by one address unit until the data blocks in the data burst corresponding to id0 are all read.

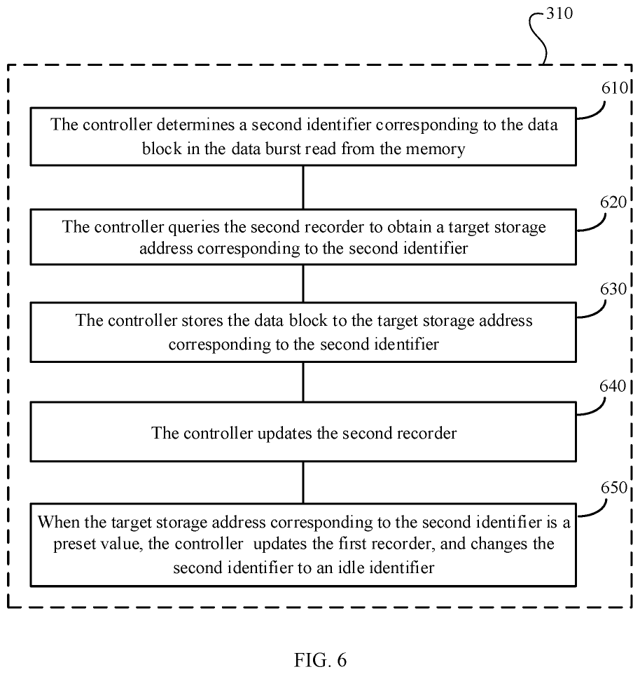

FIG. 6 illustrates a schematic flowchart of an implementation manner of an exemplary step 310 shown in FIG. 3. In one embodiment, based on the introduction of the second recorder 184, the exemplary step 310 shown in FIG. 3 may be implemented in a manner as shown in FIG. 6. The implementation shown in FIG. 6 may include exemplary steps 610-650, which are described in detail below.

In the exemplary step 610, the controller 183 may determine a second identifier corresponding to the data block in the data burst read from the memory 14.

In one embodiment, the second identifier may be any identifier in the busy identifiers.

A data burst may correspond to a read identifier, and each data block read from the memory 14 may include a corresponding read identifier to indicate the data burst to which the data block belongs. Taking the bus 16 as an AXI bus as an example, the bus 16 may be able to transmit not only the read data block, but also the read identifier corresponding to the data block. The controller 183 may, based on the read identifier corresponding to the data block, determine the busy identifier to which the data block in the data burst read from the memory 14 belongs.

In the exemplary step 620, the controller 183 may query the second recorder 184 to obtain a target storage address corresponding to the second identifier.

In the exemplary step 630, the controller 183 may store the data block to the target storage address corresponding to the second identifier.

In the exemplary step 640, the controller 183 may update the second recorder 184.

For example, the controller 183 may increase the target storage address corresponding to the second identifier recorded in the second recorder 184 by one address unit.

In the exemplary step 650, when the target storage address corresponding to the second identifier is a preset value, the controller 183 may update the first recorder 181, and change the second identifier to an idle identifier. In this way, the second identifier may continue to be used for reading subsequent data bursts.

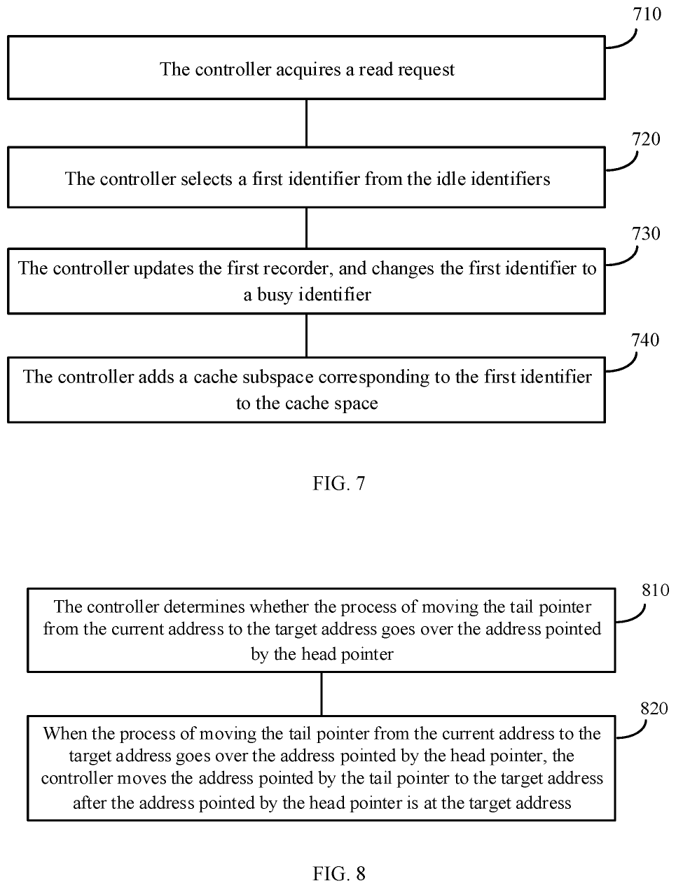

FIG. 7 illustrates a schematic flowchart of another exemplary method for controlling a data caching device according to an embodiment of the present disclosure. In some embodiments, the controller 183 may be further configured to execute a control method as shown in FIG. 7. The control method of FIG. 7 may include exemplary steps 710-740, which are described in detail below.

In the exemplary step 710, the controller 183 may acquire a read request.

The read request may be used to read a new data burst. The read request may be generated, for example, by the CPU 12 in the data processing system 10 according to actual needs, and may notify the data caching device 18 to read the corresponding data.

In the exemplary step 720, the controller 183 may select a first identifier from the idle identifiers.

The embodiments of the present disclosure do not specifically limit the manner in which the controller 183 selects the first identifier from the idle identifiers. The first identifier may be randomly selected, or may be selected according to certain rules.

As an example, the first identifier may be selected from the idle identifiers through a preset encoder based on the busy/idle statuses of the plurality of read identifiers. In other words, the input of the preset encoder may be the busy/idle statuses of the plurality of read identifiers, and the output may be an identifier selected from the idle identifiers. The preset encoder may specifically be pre-recorded mapping relationship information (such as a mapping relationship table), and the mapping relationship information may be used to indicate a mapping relationship between each busy/idle status of the plurality of read identifiers and the selected idle identifier. Taking outstanding8 as an example, the busy/idle statuses of the eight read identifiers may be represented by 8 bits, and the output result may have a total of 8 possibilities. Therefore, it may be represented by 3 bits. In this case, the above encoder can be set to an 8-3 encoder to indicate the selected idle identifier corresponding to each state of the 8 bits.

For example, the configuration of the encoder may be such that the first identifier is the identifier having the smallest value in the idle identifiers. For example, in the initial state of the data caching device 18, the eight read identifiers are all idle identifiers. When data needs to be read, the configuration of the encoder may make the controller 183 set id0 as the busy flag first. In any operation state, the configuration of the encoder may make the controller 183 always set the id having the smallest value as the busy identifier first. The above configuration of the encoder is simple to implement and may simplify the control logic of the controller 183.

In the exemplary step 730, the controller 183 may update the first recorder, and change the first identifier to a busy identifier.

In the exemplary step 740, the controller 183 may add a cache subspace corresponding to the first identifier to the cache space. It should be understood that the cache subspace corresponding to the first identifier may be used to store the new data burst.

As an example, the address pointed by the tail pointer may be moved from the current address to the target address to form a cache subspace corresponding to the first identifier, such that the storage capacity of the cache subspace corresponding to the first identifier is equal to the size of the new data burst.

For example, in the initial state (such as after the hardware reset of the data caching device 18), both the head pointer and the tail pointer can point to the first address of the cache space, i.e., address 0 of the cache 182. Taking outstanding8 as an example, assuming that a data burst contains 8 data blocks (e.g., burst8) and each data block occupies a storage address in the cache space, when a new data burst needs to be read, a certain read identifier (such as id0) in id0-id7 may be set as the busy identifier first, and the tail pointer may be moved backward by 8 storage addresses to form a cache subspace corresponding to the busy identifier id0. The cache subspace is composed of addresses 0 to 7 of the cache 182, and eight data blocks in the data burst corresponding to id0 can be sequentially written into addresses 0 to 7. Further, when the next data burst needs to be read, one of the remaining idle identifiers (id1˜id7) may be set as a busy identifier, and the tail pointer may be moved backward by 8 storage addresses again to form a cache subspace corresponding to id1. The above operations may be performed repeatedly until all 8 read identifiers are used.

FIG. 8 illustrates a schematic flowchart of another exemplary method for controlling a data caching device according to an embodiment of the present disclosure. In one embodiment, since the cache 182 needs to be recycled, the tail pointer may catch up with the head pointer. When the tail pointer moves past the head pointer, a conflict may take place. In order to avoid such a conflict, the controller 183 may also execute a control method as shown in FIG. 8 before moving the address pointed by the tail pointer from the current address to the target address.

Referring to FIG. 8, the control method may include exemplary steps 810-820, which are described in detail below.

In the exemplary step 810, the controller 183 may determine whether the process of moving the tail pointer from the current address to the target address goes over the address pointed by the head pointer.

In the exemplary step 820, when the process of moving the tail pointer from the current address to the target address goes over the address pointed by the head pointer, after the address pointed by the head pointer is at the target address, the controller 183 may then move the address pointed by the tail pointer to the target address.

According to the embodiments of the present disclosure, before moving the tail pointer, whether the movement of the tail pointer goes over the address pointed by the head pointer may be determined first. As such, the conflict between the head pointer and the tail pointer (e.g., the address pointed by the tail pointer becoming ahead of the address pointed by the heat pointer) may be avoided.

The exemplary step 810 may be implemented in multiple forms. Among these possible implementations, an implementation is described in detail below.

First, each of the head and tail pointers may be represented by a plurality of bits. The plurality of bits may include a plurality of first-type bits and a plurality of second-type bits. The plurality of first-type bits corresponding to the head pointer may be used to indicate the address pointed to by the head pointer. The plurality of first-type bits corresponding to the tail pointer may be used to indicate the address pointed to by the tail pointer. The value of the plurality of second-type bits corresponding to the head pointer same as the value of the plurality of second-type bits corresponding to the tail pointer may be used to indicate that the head pointer and the tail pointer correspond to a same cycle of the loop access process. The value of the plurality of second-type bits corresponding to the head pointer different from the value of the plurality of second-type bits corresponding to the tail pointer may be used to indicate that the cycle corresponding to the tail pointer is a next cycle of the cycle corresponding to the head pointer.

After the head pointer and the tail pointer are defined in the above manner, the exemplary step 810 may be performed as follows.

First, whether the plurality of second-type bits corresponding to the head pointer is the same as the plurality of second-type bits corresponding to the tail pointer may be determined. When the plurality of second-type bits corresponding to the head pointer is different from the plurality of second-type bits corresponding to the tail pointer, the relationship between the target address and the address pointed by the head pointer may be determined. When the target address is less than or equal to the address pointed by the head pointer, it may be determined that the process of moving the tail pointer from the current address to the target address does not go over the address pointed by the head pointer; when the target address is greater than the address pointed by the head pointer, it may be determined that the process of moving the tail pointer from the current address to the target address goes over the address pointed by the head pointer.

Taking the address depth of the cache 182 equal to 16 as an example, both the head pointer and the tail pointer can be represented by 5 bits. The lower 4 bits of the 5 bits corresponding to each pointer may correspond to the above-mentioned first-type bits, and may be used to indicate which of the 16 storage addresses the pointer points to. The highest bit of the 5 bits corresponding to each pointer may correspond to the above-mentioned second-type bit. The initial value of the highest bit of the head pointer and the highest bit of the tail pointer may be 0. After a pointer moves from the last address of the cache 182 to the first address of the cache 182, the value of the highest bit of the pointer may be changed. For example, the bit may be considered as a 5-bit number, and when the head pointer or tail pointer exceeds 15, e.g. from 15 to 16, the corresponding number of the bits may change from 01111 to 10000. As such, the first bit (second-type bit) may change, so back and forth. When the values of the highest bit of the head pointer and the tail pointer are the same, it means that the head pointer and the tail pointer correspond to the same loop in the loop access process. When the most significant bits of the head pointer and the tail pointer are different, it may indicate that the tail pointer has entered the next cycle of the loop access process. In such a case, when the storage address pointed by the tail pointer exceeds the storage address pointed by the head pointer, the head pointer and the tail pointer may conflict each other. According to the embodiments of the present disclosure, based on the control logic shown in FIG. 8, such a conflict may be effectively avoided.

The embodiments of the present disclosure only need to simply compare whether the second-type bits corresponding to the head pointer and the tail pointer are the same to determine whether the head pointer and the tail pointer are in a same cycle, and then determine whether the head pointer and the tail pointer conflict to each other. The determination logic according to the embodiments of the present disclosure may be easy for implementation.

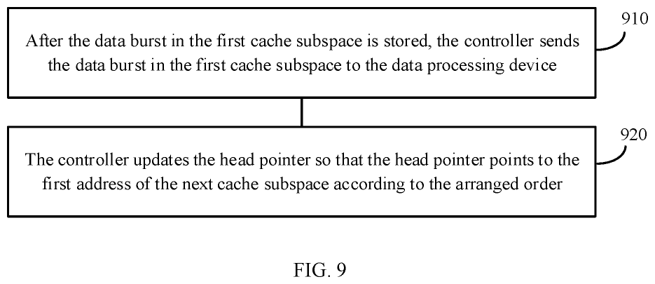

FIG. 9 illustrates a schematic flowchart of another exemplary method for controlling a data caching device according to an embodiment of the present disclosure. Referring FIG. 9, the method for controlling a data caching device may include exemplary steps 910-920, which are described in detail below.

In the exemplary step 910, after the data burst in the first cache subspace is stored, the controller 183 may send the data burst in the first cache subspace to the data processing device 19.

The first cache subspace may be a cache subspace at which the address pointed by the head pointer is located. Assuming that the head pointer points to an address n in the cache 182, the first cache subspace may be a cache subspace containing the address n. The address n may be, for example, the first address of the first cache subspace.

In the exemplary step 920, the controller 183 may update the head pointer so that the head pointer points to the first address of the next cache subspace according to the arranged order.

In one embodiment, after reading the data burst in the cache subspace pointed by the head pointer of the data caching device 18 is completed, the data burst may be directly sent to the data processing device 19 for the data processing device 19 to use.

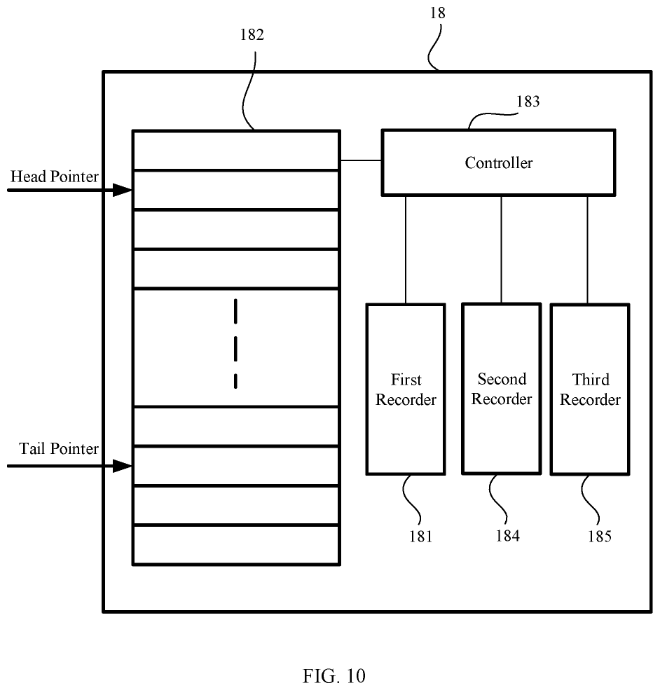

FIG. 10 illustrates a schematic structural diagram of another exemplary data caching device according to an embodiment of the present disclosure. Referring to FIG. 10, in another embodiment, the data caching device 18 may further include a third recorder 185. The third recorder 185 may be configured to record the busy/idle status of the data processing device 19. Prior to sending the data burst stored in the first cache subspace to the data processing device 19, the controller 183 may first query the third recorder 185 to determine the busy/idle status of the data processing device 19. When the data processing device 19 is in a busy state, the controller 183 may wait for the data processing device 19 to be idle before sending the data burst stored in the first cache subspace to the data processing device 19. This implementation manner introduces a third recorder 185 for recording the busy/idle status of the data processing device 19, and determines whether data can be sent to the data processing device 19 based on the third recorder 185. As such, data loss or data processing failure due to the data processing device 19 being in the busy state may be avoided.

In the following, by taking the data caching device 18 supporting outstanding8, and a data burst including 8 data blocks as an example, the embodiments of the present disclosure will be described in more detail. It should be noted that the following examples are merely to help those skilled in the art understand the embodiments of the present disclosure, and are not intended to limit the embodiments of the present disclosure to the specific numerical values or specific scenarios illustrated. Those skilled in the art can obviously make various equivalent modifications or changes according to the following examples, and such modifications or changes should also fall within the scope of the embodiments of the present disclosure.

In one embodiment, the data caching device 18 may support outstanding8. Therefore, the data caching device 18 may be pre-configured with eight read identifiers, which are represented by id0 to id7 below.

The first recorder 181 in the data caching device 18 may be an 8-bit register. The eight bits of the register may one by one correspond to the eight read identifiers, and each bit may be used to indicate the busy/idle status of the read identifier corresponding to the bit. For example, a bit with a value of 0 may indicate that the read identifier corresponding to the bit is idle, that is, the read identifier corresponding to the bit is not used to read the data burst; a bit with a value of 1 may indicate that the read identifier corresponding to the bit is a busy identifier, that is, the data caching device 18 is reading a data burst corresponding to the read identifier.

In one embodiment, the second recorder 184 in the data caching device 18 may be a register file. Each row of the register file may correspond to a read identifier, and may be used to indicate a target storage address corresponding to the read identifier. The target storage address may be understood as the storage address of the next data block in the data burst corresponding to the read identifier.

Each time when the data caching device 18 reads back a data block from the bus 16, the controller 183 may query the second recorder 184 based on the read identifier corresponding to the data block to obtain the storage address of the data block. Then, the controller 183 may cache the data block into a corresponding storage address, and add an address unit to the target storage address corresponding to the read identifier recorded in the second recorder 184. When the data block that is currently read back is the last data block of the data burst, the controller 183 may update the first recorder 181 to set the read identifier as an idle identifier, such that the read identifier can be used for transmitting subsequent data bursts.

In one embodiment, idle_id may be used to indicate an idle identifier, and idle_id may be generated by the priority 8-3 encoder. For example, the priority 8-3 encoder may be configured such that id0 has the highest priority, that is, when the id numbered as 0 is an idle identifier, the encoder may always decode idle_id to 0. Otherwise, the encoder may sequentially determine the busy/idle statuses of id1˜id7, and set the idle identifier having the smallest value to the selected idle_id output by the encoder.

In one embodiment, the size of the cache 182 may be set to twice the amount of data supported by the data caching device 18 in an outstanding transmission manner. Assuming that the data width of the cache 182 is equal to the read-data bit width of the bus 16 and a data burst contains 8 data blocks, the address depth of the cache 182 may be set to 8×8×2=128.

Further, in order to realize the cycling utilization of the storage space of the cache 182, two pointers are provided in the embodiment of the present disclosure: a head pointer and a tail pointer. The head pointer may point to the start address of the first data burst stored in the cache 182, and the tail pointer may point to the start address of the next data burst that the cache 182 needs to store.

In the following, an embodiment of the present disclosure is described in detail using an outstanding8 transmission process as an example. After the data caching device 18 is reset by hardware, the values of the 8-bit register in the first recorder 181 may all be 0, indicating that id0-id7 are all idle identifiers; both the head pointer and the tail pointer of the cache 182 may point to address 0 of the cache 182.

Further, assuming that the data caching device 18 needs to read multiple data bursts, when the 8-3 encoder detects that idle_id is id0, the controller 183 may update the first recorder 181 to record id0 as a busy identifier. Further, the controller 183 may use address 0 pointed by the tail pointer as the target storage address corresponding to id0, and may record it in the register corresponding to id0 in the second recorder 184. Then, the controller 183 may add 8 (increased by 8 address units) to the address pointed by the tail pointer to form a cache subspace corresponding to id0 (the cache subspace contains addresses 0 to address 7 of the cache 182). The cache subspace corresponding to id0 may be used to store eight data blocks in the data burst read back based on id0. In the next clock cycle, the controller 183 may detect idle_id as id1 based on the 8-3 encoder, and repeat the above operation to use the address pointed by the tail pointer as the target storage address corresponding to id1 and record it in the register corresponding to id1 in the second recorder 184. The controller 183 may then add 8 to the address pointed by the tail pointer to form a cache subspace corresponding to id1 (the cache subspace contains address 8 to address 15 of the cache 182). Further, the above operation may be repeated until all 8 read identifiers are set as busy identifiers. At this time, the data caching device 18 may need to wait for the moment when there is an idle identifier before able to read a new data burst. When all 8 data blocks in the data burst corresponding to id0 are read back, the first recorder 181 may be updated, and id0 is set as an idle identifier, indicating that id0 can be used continuously, e.g. id0 becomes available again. Since the data burst corresponding to id0 is placed in the cache subspace pointed to by the head pointer of the cache 182, the data burst corresponding to id0 can be immediately sent to the data processing device 19. For example, 8 clock cycles may be used to sequentially send the 8 data blocks in the data burst corresponding to id0 to the data processing device 19, and then the address pointed by the head pointer may be added by 8. When the data block in the data burst corresponding to id4 is read first, because the start address of the cache subspace corresponding to id4 is not the address pointed by the head pointer, the data block stored in the cache subspace corresponding to id4 may be sent to the data processing device 19 after the head pointer of the cache 182 points to the start address of the cache subspace corresponding to id4. However, after all the data blocks in the data burst corresponding to id4 are read, id4 can be changed to an idle identifier for reading subsequent data bursts. The controller 183 may repeatedly execute the above process until all data bursts are read back.

In most of the time periods, the data caching device 18 provided by the embodiments of the present disclosure is able to ensure that the outstanding utilization rate is always 8. In addition, based on the use of the head pointer and the tail pointer, and the recording of information required for the control process by the first recorder 181 and the second recorder 184, the data caching device 18 is able to circulate the use of the storage space of the cache 182, thereby reducing the use of on-chip cache resources required by the data processing process.

The present disclosure further provides a data processing chip. The data processing chip may be, for example, a data processing chip 17 schematically illustrated in FIG. 1. Referring to FIG. 1, the data processing chip 17 may include a data caching device 18 and a data processing device 19.

The present disclosure further provides a data processing system. The data processing system may be, for example, a data processing system 10 schematically illustrated in FIG. 1. Referring to FIG. 1, the data processing system 10 may include a bus 16, a data processing chip 17, and a CPU 12.

The present disclosure further provides a control method of a data caching device. The data caching device may include a first recorder, configured to record busy identifiers and idle identifiers in a plurality of read identifiers. The plurality of read identifiers may be preset. Each busy identifier may correspond to a data burst to be read. The data caching device may also include a cache. The cache may include a head pointer and a tail pointer for performing loop access to the cache, and a cache space defined by the head pointer and the tail pointer. The cache space may include a cache subspace corresponding to each busy identifier, and the cache subspace corresponding to each busy identifier may be used to store a corresponding data burst.

FIG. 3 illustrates a schematic flowchart of an exemplary control method of a data caching device according to an embodiment of the present disclosure. Referring to FIG. 3, the control method may include the following exemplary steps.

In an exemplary step 310, the controller may write the data burst read from a memory into a cache subspace corresponding to each busy identifier in a preset order.

In an exemplary step 320, when the last data block of the data burst is written in the cache subspace corresponding to the busy identifier, the controller may update the first recorder, and change the busy identifier to an idle identifier.

In one embodiment, referring to FIG. 7, the control method may also include the following exemplary steps.

In an exemplary step 710, the controller may acquire a read request. The read request may be used to read a new data burst.

In an exemplary step 720, the controller may select a first identifier from the idle identifiers.

In an exemplary step 730, the controller may update the first recorder, and change the first identifier to a busy identifier.

In an exemplary step 740, the controller may add a cache subspace corresponding to the first identifier to the cache space. The cache subspace corresponding to the first identifier may be used to store the new data burst.

In one embodiment, the exemplary step 720 may include the following: the controller may select the first identifier from the idle identifiers through a preset encoder based on the busy/idle statuses of the plurality of read identifiers.

In one embodiment, the encoder may be configured to select an idle identifier having the smallest value in the idle identifiers as the first identifier.

In one embodiment, the exemplary step 740 may include the following: the controller may move the address pointed by the tail pointer from a current address to a target address to form the cache subspace corresponding to the first identifier, such that the storage capacity of the cache subspace corresponding to the first identifier is equal to the size of the new data burst.

In one embodiment, referring to FIG. 8, before the address pointed is moved by the tail pointer from the current address to the target address, the control method may further include the following exemplary steps.

In an exemplary step 810, the controller may determine whether the process of moving the tail pointer from the current address to the target address goes over the address pointed by the head pointer.

In an exemplary step 820, when the process of moving the tail pointer from the current address to the target address goes over the address pointed by the head pointer, after the address pointed by the head pointer is at the target address, the controller may then move the address pointed by the tail pointer to the target address.

In one embodiment, each of the head and tail pointers may be represented by a plurality of bits. The plurality of bits may include a plurality of first-type bits. The plurality of first-type bits corresponding to the head pointer may be used to indicate the address pointed to by the head pointer, and the plurality of first-type bits corresponding to the tail pointer may be used to indicate the address pointed to by the tail pointer.

In one embodiment, the plurality of bits may also include a plurality of second-type bits. The value of the plurality of second-type bits corresponding to the head pointer same as the value of the plurality of second-type bits corresponding to the tail pointer may be used to indicate that the head pointer and the tail pointer correspond to a same cycle of the loop access process. The value of the plurality of second-type bits corresponding to the head pointer different from the value of the plurality of second-type bits corresponding to the tail pointer may be used to indicate that the cycle corresponding to the tail pointer is a next cycle of the cycle corresponding to the head pointer.

In one embodiment, the exemplary step 810 may also include the following: when the plurality of second-type bits corresponding to the head pointer is different from the plurality of second-type bits corresponding to the tail pointer, the controller may determine the relationship between the target address and the address pointed by the head pointer; when the target address is less than or equal to the address pointed by the head pointer, the controller may determine that the process of moving the tail pointer from the current address to the target address does not go over the address pointed by the head pointer; and when the target address is greater than the address pointed by the head pointer, the controller may determine that the process of moving the tail pointer from the current address to the target address goes over the address pointed by the head pointer.

In one embodiment, the exemplary step 310 may include the following: the controller may, according to a response order of the memory to the read request corresponding to each identifier in the busy identifiers, sequentially write the data burst corresponding to each identifier in the busy identifiers into the cache subspace corresponding to the identifier.

In one embodiment, the exemplary step 310 may include the following: the controller may, according to a reading order of the data blocks in the data burst corresponding to each identifier in the busy identifiers (e.g., the order in which the data block in the data burst corresponding to each identifier in the busy identifiers are read), sequentially write data blocks in the data burst corresponding to each identifier in the busy identifiers into the cache subspace corresponding to the identifier.

In one embodiment, the data caching device may further include a second recorder. The second recorder may be configured to record a target storage address of the cache subspace corresponding to the busy identifier. The target storage address may be a storage address of a next data block in the data burst corresponding to the busy identifier. Correspondingly, referring to FIG. 6, the exemplary step 310 may include the following exemplary steps.

In an exemplary step 610, the controller may determine a second identifier corresponding to the data block in the data burst read from the memory. The second identifier may be any identifier in the busy identifiers.

In an exemplary step 620, the controller may query the second recorder 184 to obtain a target storage address corresponding to the second identifier.

In an exemplary step 630, the controller may store the data block to the target storage address corresponding to the second identifier.

In an exemplary step 640, the controller may update the second recorder.

In one embodiment, the exemplary step 640 may include the following: the controller may increase the target storage address corresponding to the second identifier recorded in the second recorder by one address unit.

In one embodiment, the control method may further include the following: when the target storage address corresponding to the second identifier is a preset value, the controller may update the first recorder, and change the second identifier to an idle identifier.

In one embodiment, the control method may further include the following: the controller may determine the quantity of the data blocks written in the cache subspace corresponding to the busy identifier; when the quantity of the data blocks written in the cache subspace corresponding to the busy identifier reaches a preset quantity, the controller may determine that the last data block of the data burst is written into the cache subspace corresponding to the busy identifier. The preset quantity is equal to the quantity of the data blocks contained in a data burst.

In one embodiment, referring to FIG. 9, the control method may further include the following exemplary steps.

In an exemplary step 910, after the data burst in the first cache subspace is stored, the controller may send the data burst in the first cache subspace to the data processing device. The first cache subspace may be a cache subspace at which the address pointed by the head pointer is located.

In an exemplary step 920, the controller may update the head pointer so that the head pointer points to the first address of the next cache subspace according to the arranged order.

In one embodiment, the data caching device may further include a third recorder. The third recorder may be configured to record the busy/idle status of the data processing device. Prior to performing the exemplary step 910, the control method may further include the following: the controller may first query the third recorder to determine the busy/idle status of the data processing device; and when the data processing device is in a busy state, the controller may wait for the data processing device to be idle before sending the data burst stored in the first cache subspace to the data processing device.

In one embodiment, the recorders in the data caching device may be registers.

In one embodiment, the next address of the last address of the cache may be the first address of the cache.

In the above embodiments, it may be implemented in whole or in part by software, hardware, firmware, or any other combination. When implemented in software, it may be implemented in whole or in part in the form of a computer program product. The computer program product includes one or more computer instructions. When the computer program instructions are loaded and executed on a computer, the processes or functions according to the embodiments of the present disclosure are wholly or partially generated. The computer may be a general-purpose computer, a special-purpose computer, a computer network, or other programmable devices. The computer instructions may be stored in a computer-readable storage medium or transmitted from one computer-readable storage medium to another computer-readable storage medium, for example, the computer instructions may be transmitted from a website, computer, server, or data center to another website, computer, server or data center via a wired (such as coaxial cable, optical fiber, digital subscriber line (DSL)) or wireless (such as infrared, wireless, microwave, etc.) method. The computer-readable storage medium may be any available medium that can be accessed by a computer or a data storage device such as a server, a data center, etc. that includes one or more available medium integration. The available medium may be a magnetic medium (for example, a floppy disk, a hard disk, a magnetic tape), an optical medium (for example, a digital video disc (DVD)), or a semiconductor medium (for example, a solid state disk (SSD)), etc.

It should be noted that, under the premise of no conflict, the embodiments described in this application and/or the technical features in each embodiment can be arbitrarily combined with each other, and the technical solution obtained after the combination should also fall into the protection scope of this application.

Those of ordinary skill in the art may understand that the units and algorithm steps of each example described in combination with the embodiments disclosed herein can be implemented by electronic hardware, or a combination of computer software and electronic hardware. Whether these functions are performed in hardware or software depends on the specific application and design constraints of the technical solution. Those of ordinary skill in the art can use different methods to implement the described functions for each specific application, but such implementation should not be considered to be beyond the scope of this application.

In the various embodiments provided by the present application, it should be understood that the disclosed systems, devices, and methods may be implemented in other manners. For example, the device embodiments described above are merely illustrative. For instance, in various embodiments of the present disclosure, the units are divided or defined merely according to the logical functions of the units, and in actual applications, the units may be divided or defined in another manner. For example, multiple units or components may be combined or integrated into another system, or some features can be ignored or not executed. In addition, the mutual coupling or direct coupling or communication connection shown or discussed may be an indirect coupling or communication connection through some interface, device or unit, and may be in an electrical, mechanical, or other form.

The units described as separate components may or may not be physically separated, and the components displayed as a unit may or may not be physical in a unit, that is, they may be located in one place, or may be distributed to multiple network units. Some or all of the units may be selected according to actual needs to achieve the purpose of the solution of the embodiment.

In addition, each functional unit in each embodiment of the present application may be integrated into one processing unit, or each unit may exist physically separately, or two or more units may be integrated into one unit.

Finally, it should be noted that the above embodiments are merely illustrative of, but not intended to limit, the technical solutions of the present invention; although the present disclosure has been described in detail with reference to the above embodiments, those skilled in the art should understand that the technical solutions described in the above embodiments may be modified, or part or all of the technical features may be equivalently replaced; and the modifications or substitutions do not depart from the scope of the technical solutions of the embodiments of the present disclosure.

What is claimed is:

1. A data caching device, comprising:
a first recorder, configured to record busy identifiers and idle identifiers in a plurality of read identifiers, wherein each busy identifier corresponds to a data burst to be read;
a cache, including a head pointer, a tail pointer, and a cache space defined by the head pointer and the tail pointer, wherein the head pointer and the tail pointer are configured to perform a loop access to the cache, the cache space includes a cache subspace corresponding to each busy identifier, and the cache subspace corresponding to each busy identifier is configured to store the corresponding data burst; and
a controller, configured to write a data burst read from a memory into the cache subspace corresponding to each busy identifier in a preset order, and in response to a last data block of the data burst being written in the cache subspace corresponding to the busy identifier, update the first recorder, and change the busy identifier to an idle identifier.

2. The data caching device according to claim 1, wherein the controller is further configured to:
acquire a read request for reading a new data burst;
select a first identifier from the idle identifiers of the plurality of read identifiers, the plurality of read identifiers being preset;
update the first recorder, and change the first identifier to a busy identifier; and
add a cache subspace corresponding to the first identifier to the cache space, wherein the cache subspace corresponding to the first identifier is configured to store the new data burst.

3. The data caching device according to claim 2, wherein when the first identifier is selected from the idle identifiers of the plurality of read identifiers, the controller is configured to:
select the first identifier from the idle identifiers through a preset encoder based on busy/idle statuses of the plurality of read identifiers.

4. The data caching device according to claim 3, wherein:
the encoder is configured to select an idle identifier having a smallest value in the idle identifiers as the first identifier.

5. The data caching device according to claim 2, wherein the cache subspace corresponding to the first identifier is added to the cache space, the controller is configured to:
move an address pointed by the tail pointer from a current address to a target address to form the cache subspace corresponding to the first identifier, such that a storage capacity of the cache subspace corresponding to the first identifier is equal to a size of the new data burst.

6. The data caching device according to claim 5, wherein before the address pointed is moved by the tail pointer from the current address to the target address, the controller is further configured to:
determine whether moving the tail pointer from the current address to the target address goes over an address pointed by the head pointer; and
in response to determining that moving the tail pointer from the current address to the target address goes over an address pointed by the head pointer, move the address pointed by the tail pointer to the target address after the address pointed by the head pointer is at the target address.

7. The data caching device according to claim 6, wherein:
each of the heat pointer and the tail pointer is represented by a plurality of bits; and
the plurality of bits includes a plurality of first-type bits, wherein:
the plurality of first-type bits corresponding to the head pointer is configured to indicate the address pointed to by the head pointer; and
the plurality of first-type bits corresponding to the tail pointer is configured to indicate the address pointed to by the tail pointer.

8. The data caching device according to claim 7, wherein:
the plurality of bits includes a plurality of second-type bits, wherein:
a value of the plurality of second-type bits corresponding to the head pointer same as a value of the plurality of second-type bits corresponding to the tail pointer is configured to indicate that the head pointer and the tail pointer correspond to a same cycle of a loop access process; and
the value of the plurality of second-type bits corresponding to the head pointer different from the value of the plurality of second-type bits corresponding to the tail pointer is configured to indicate that a cycle corresponding to the tail pointer is a next cycle of the cycle corresponding to the head pointer.

9. The data caching device according to claim 8, wherein for determining whether moving the tail pointer from the current address to the target address goes over the address pointed by the head pointer, the controller is further configured to:
in response to the plurality of second-type bits corresponding to the head pointer being different from the plurality of second-type bits corresponding to the tail pointer, determine a relationship between the target address and the address pointed by the head pointer;
in response to the target address being less than or equal to the address pointed by the head pointer, determine that moving the tail pointer from the current address to the target address does not go over the address pointed by the head pointer; and
in response to the target address being greater than the address pointed by the head pointer, determine that moving the tail pointer from the current address to the target address goes over the address pointed by the head pointer.

10. The data caching device according to claim 1, wherein for writing the data burst read from the memory into the cache subspace corresponding to each busy identifier in the preset order, the controller is configured to:
according to a response order of the memory to the read request corresponding to each identifier in the busy identifiers, sequentially write the data burst corresponding to each identifier in the busy identifiers into the cache subspace corresponding to the identifier.

11. The data caching device according to claim 10, wherein for writing the data burst read from the memory into the cache subspace corresponding to each busy identifier in the preset order, the controller is configured to:
according to a reading order of data blocks in the data burst corresponding to each identifier in the busy identifiers, sequentially write the data blocks in the data burst corresponding to each identifier in the busy identifiers into the cache subspace corresponding to the identifier.

12. The data caching device according to claim 1, further including a second recorder, configured to record a target storage address of the cache subspace corresponding to the busy identifier, wherein:
the target storage address is a storage address of a next data block in the data burst corresponding to the busy identifier; and
for writing the data burst read from the memory into the cache subspace corresponding to each busy identifier in the preset order, the controller is configured to:
determine a second identifier corresponding to the data block in the data burst read from the memory, wherein the second identifier is any identifier in the busy identifiers;
query the second recorder to obtain a target storage address corresponding to the second identifier;
store the data block to the target storage address corresponding to the second identifier; and
update the second recorder.

13. The data caching device according to claim 12, wherein for updating the second recorder, the controller is configured to:
increase the target storage address corresponding to the second identifier recorded in the second recorder by one address unit.

14. The data caching device according to claim 13, wherein the controller is further configured to:
in response to the target storage address corresponding to the second identifier being a preset value, update the first recorder, and change the second identifier to an idle identifier.

15. The data caching device according to claim 1, wherein the controller is further configured to:
determine a quantity of data blocks written in the cache subspace corresponding to the busy identifier; and
in response to the quantity of the data blocks written in the cache subspace corresponding to the busy identifier reaching a preset quantity, determine that the last data block of the data burst is written into the cache subspace corresponding to the busy identifier, wherein the preset quantity is equal to the quantity of data blocks contained in a data burst.

16. The data caching device according to claim 1, wherein the controller is further configured to:
after the data burst in the first cache subspace is stored, send the data burst in the first cache subspace to the data processing device, wherein the first cache subspace is a cache subspace at which the address pointed by the head pointer is located; and
update the head pointer so that the head pointer points to a first address of a next cache subspace according to an arranged order.

17. The data caching device according to claim 1, further including a third recorder, configured to record a busy/idle status of the data processing device, wherein:
the controller is further configured to:
prior to sending the data burst in the first cache subspace to the data processing device, query the third recorder to determine the busy/idle status of the data processing device; and
in response to the data processing device being in a busy state, wait for the data processing device to be idle before sending the data burst stored in the first cache subspace to the data processing device.

18. The data caching device according to claim 1, wherein:
the first recorder is a register.

19. A data processing chip, comprising:
a data caching device; and
a data processing device, coupled to the data caching device and configured to process data received from the data caching device, wherein the data caching device includes:
a first recorder, configured to record busy identifiers and idle identifiers in a plurality of read identifiers, wherein each busy identifier corresponds to a data burst to be read;
a cache, including a head pointer, a tail pointer, and a cache space defined by the head pointer and the tail pointer, wherein the head pointer and the tail pointer are configured to perform loop access to the cache, the cache space includes a cache subspace corresponding to each busy identifier, and the cache subspace corresponding to each busy identifier is configured to store the corresponding data burst; and
a controller, configured to write the data burst read from a memory into the cache subspace corresponding to each busy identifier in a preset order, and in response to a last data block of the data burst being written in the cache subspace corresponding to the busy identifier, update the first recorder, and change the busy identifier to an idle identifier.

20. A data processing system, comprising:
a bus;
a data processing chip, including a data caching device and a data processing device, wherein:
the data processing device is coupled to the data caching device and configured to process data received from the data caching device, and
the data caching device includes:
a first recorder, configured to record busy identifiers and idle identifiers in a plurality of read identifiers, wherein each busy identifier corresponds to a data burst to be read,
a cache, including a head pointer, a tail pointer, and a cache space defined by the head pointer and the tail pointer, wherein the head pointer and the tail pointer are configured to perform loop access to the cache, the cache space includes a cache subspace corresponding to each busy identifier, and the cache subspace corresponding to each busy identifier is configured to store the corresponding data burst, and
a controller, configured to write the data burst read from a memory into the cache subspace corresponding to each busy identifier in a preset order, and in response to a last data block of the data burst being written in the cache subspace corresponding to the busy identifier, update the first recorder, and change the busy identifier to an idle identifier; and
a central processing unit (CPU), connected to the data processing chip through the bus.
